(19) United States
(12) Patent Application Publication
(10) Pub. No.: US 2006/0200938 A1
(43) Pub. Date: Sep. 14, 2006

(54) Furniture glide with plow base

(76) Inventor: Robert N. Dombroski, Waterbury, CT (US)

Correspondence Address: ALIX YALE & RISTAS LLP, 750 MAIN STREET, SUITE 1400, HARTFORD, CT, 06103, US

(21) Appl. No.: 11/111,410

(22) Filed: Apr. 21, 2005

Related U.S. Application Data
(60) Provisional application No. 60/661,100, filed on Mar. 11, 2005.

(51) Int. Cl. B60B 33/00

(52) U.S. Cl. 16/42 R

(57) ABSTRACT

A furniture glide includes an upper portion for mounting to a furniture leg and a lower portion having a plow base. The plow base includes a lower pad segment having an outer wall that extends downwardly to a bottom sliding surface for sliding on a floor. The outer wall is substantially perpendicular to the sliding surface, forming a sharp outer edge that acts as a plow when the furniture glide is slid along the floor to push dirt or other debris out of the path of the furniture glide.

### BACKGROUND

The present invention relates to furniture glides, and more particularly to an improved furniture glide base.

Furniture glides are available in a variety of styles and constructions, but an essential purpose is to provide an upper portion for receiving a furniture leg and a lower portion defining a sliding surface. U.S. Pat. No. 5,991,974, “Swivelling Furniture Glide”, and U.S. Pat. No. 6,154,923, “High Hold Furniture Glide”, and U.S. Publication US2002/0088082A1 describe glides of the type having a three main components: (1) a ferrule including a bottom wall, an upstanding cylindrical side wall extending from the bottom wall and defining a socket for receiving a furniture leg, and clip means within the socket, for engaging a received furniture leg, (2) a swivelable glide support shell affixed to the bottom wall of the ferrule, and (3) a glide base affixed to the support shell and defining a substantially flat sliding surface for contacting the floor.

U.S. Pat. No. 6,405,982, “Self-Attaching Sliding Support for Articles of Furniture”, describes another type of glide that does not have a ferrule or swivel capability, but rather consists of a generally cup-shaped, unitary body of a resilient element for gripping the legs and an integrated slidable base element for contact with the floor.

In these and other known furniture glides, the sliding surface for contacting the floor is of a material specifically chosen for its relatively high hardness. Typical base element materials include steel (usually selected for carpeted floors) or hard plastics such as nylon or polyethylene (typically selected fortile floors and older vinyl flooring products containing asbestos). Base elements composed of steel or hard plastic provide durability, easy cleaning of the sliding surface and easy and quiet sliding of the furniture along floors surfaced with carpet or tile, respectively, without abrasion or smudging. However, modern vinyl flooring products do not contain asbestos, and as a consequence are softer than the older vinyl floor products. Furniture glides having conventional base elements tend to scratch and mar the modern vinyl flooring products. Scratching is particularly a problem if there is dirt or debris on the floor which will act as an abrasive between the bottom surface of the furniture glide base element and the floor.

### SUMMARY

Briefly stated, the subject furniture glide includes an upper portion adapted for mounting to a furniture leg and a lower portion having a plow base. The plow base includes a lower pad segment having an outer wall that extends downwardly to a bottom sliding surface for sliding on a floor.

The outer wall is substantially perpendicular to the sliding surface, forming a sharp outer edge that acts as a plow when the furniture glide is slid along the floor to push dirt or other debris out of the path of the furniture glide.

The sliding surface of the pad segment may include a recess having an inner wall that is substantially perpendicular to the sliding surface, forming a sharp inner edge. The inner edge acts as a plow when the furniture glide is slid along the floor to push dirt or other debris disposed between the bottom surface and the floor into the recess.

The plow base is molded from a polymer material, preferably monopolymer acetal. The polymer material may also include siloxane. For example, the polymer material may comprise 4 to 10% siloxane and 96 to 90% monopolymer acetal. Preferably, the polymer material comprises 4 to 5% siloxane and 96 to 95% monopolymer acetal.

The upper portion includes a ferrule assembly adapted for receiving and gripping the furniture leg. The lower portion may be pivotally mounted to the upper portion or integrally formed with the upper portion.

Alternatively, the furniture glide may be a single unitary structure, with the upper portion including a circumferential upper lip segment, a circumferential sidewall segment and a lower base segment, with the lip segment, the sidewall segment and the base segment forming a cavity for receiving a conventional furniture glide mounted on the furniture leg.

### BRIEF DESCRIPTION OF THE DRAWINGS

The present invention may be better understood and its numerous objects and advantages will become apparent to those skilled in the art by reference to the accompanying drawings in which:

FIG. 1 is a side view, partly in cross-section, of a first variety of furniture glide having a plow base in accordance with a first embodiment;

FIG. 2 is an enlarged perspective view of the plow base of FIG. 1;

FIG. 3 is a bottom view of the plow base of FIG. 1;

FIG. 4 is an enlarged view of area IV of FIG. 1;

FIG. 5 is a side view, partly in cross-section, of furniture glide having a plow base in accordance with a second embodiment;

FIG. 6 is a perspective view of the plow base of FIG. 5;

FIG. 7 is cross-sectional view of the plow base of FIG. 5;

FIG. 8 is an enlarged view of area VIII of FIG. 5;

FIG. 9 is a bottom view of a plow base having a first variation of the pad segment;

FIG. 10 is a bottom view of a plow base having a second variation of the pad segment

FIG. 11 is a top perspective view of a second variety of furniture glide having a plow base in accordance with a third embodiment;

FIG. 12 is a bottom perspective view of the furniture glide of FIG. 11;

FIG. 13 is a side view, partly in cross-section, of the furniture glide of FIG. 11;

FIG. 14 is an enlarged view of area XIV of FIG. 13;

FIG. 15 is a top perspective view of a third variety of furniture glide having a plow base in accordance with a fourth embodiment;

FIG. 16 is a bottom perspective view of the furniture glide of FIG. 15;

FIG. 17 is a side view, partly in cross-section, of the furniture glide of FIG. 15; and

FIG. 18 is an enlarged view of area XIV of FIG. 17.

### DETAILED DESCRIPTION

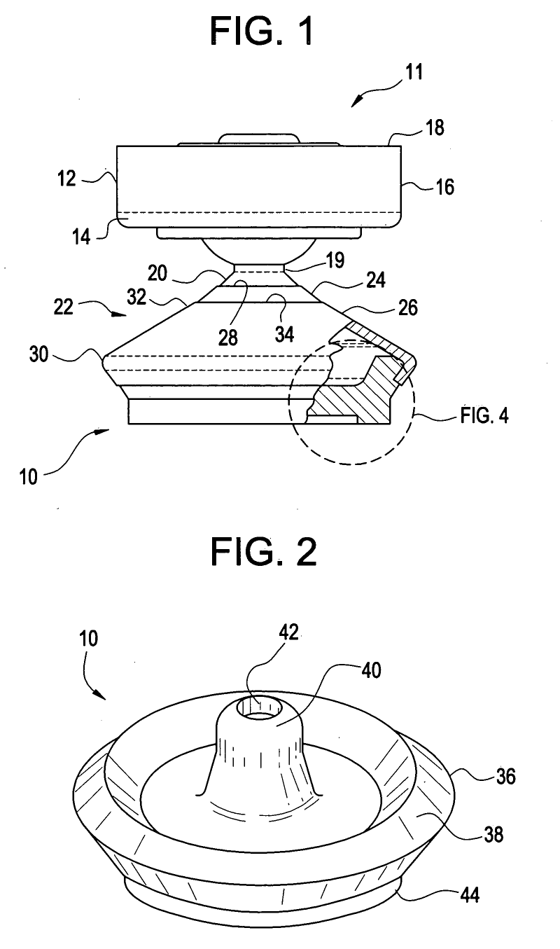

FIGS. 1-4 illustrate a first embodiment of a plow base 10, in the context of swivel furniture glides 11 such as described in U.S. Pat. No. 5,991,974, “Swivelling Furniture Glide” and U.S. Pat. No. 6,154,923, “High Hold Furniture Glide”, and U.S. Publication US2002/0088082A1, the disclosures of which are hereby incorporated by reference.

A ferrule for receiving a furniture leg, is generally designated by the numeral 12. The ferrule 12 has a circular bottom wall 14 and an upstanding cylindrical side wall 16 forming a circular ferrule opening 18. The ferrule opening 18 is preferably chosen to closely match the outer diameter of the furniture leg (not shown). The bottom wall 14 defines a circular rivet opening (not shown) coaxial with the ferrule opening 18.

A clip (not shown) disposed within the ferrule 12 may take a variety of forms. For example, the clip may be formed from a longitudinal resilient metal strip. The clip has a clip base which has a footprint smaller than the ferrule opening 18, and a single pair of oppositely positioned clip arms. The clip arms extend generally perpendicularly upward from the clip base. The unstressed clip arms define a neutral diameter greater than the diameter of the ferrule opening 18. The arms and base of the clip are resiliently deformable whereby as the clip is inserted base first into the ferrule opening 18, the clip arms deform inwardly to the smaller diameter of the ferrule opening 18. The clip arms return to generally the neutral shape after passage through the ferrule opening 18. The clip base defines a central clip rivet opening. The clip rivet opening is aligned with the ferrule rivet opening when the clip is mounted in the ferrule 12. The rivet openings are of the same diameter.

A rivet 19 is secured through the clip and ferrule rivet openings. The rivet 19 has an expandable head portion (not shown) and an opposite swivel portion 20. The head portion of the rivet 19 is inserted through the aligned rivet openings and rounded or peened over to pull the swivel portion 20 against the bottom wall 14 of the ferrule 12. The rivet 19 securely fastens the ferrule 12 and clip together. The clip and ferrule 12, when riveted together, are capable of fully supporting a furniture leg, and therefore preferably do not require any additional structural elements. The swivel portion 20 of the rivet 19 extends downward from the bottom wall 14 and radially outward to define a convex spherical outer swivel surface and a concentric inner spherical swivel surface.

A shell assembly 22, having an inner shell 24 and an outer shell 26, slidably engages the outer swivel surface of the rivet 19. The inner shell 24 is generally spherical and defines a circular inner shell opening 28 having a diameter less than the swivel portion 2 of the rivet 19. The inner shell 24 is nested within the outer shell 26. The outer shell 26 has a generally frustoconical shape forming an expanded portion 30 defining an outer edge and a reduced portion 32. The outer shell 26 defines a circular outer shell opening 34 at the reduced portion 32 having a diameter less than the outer diameter of the inner shell 24. The spherical shape of the inner shell 24 allows for improved swiveling sliding engagement of the inner shell 24 with the outer shell 26.

The plow base 10 is mounted to the expanded portion 30 of the outer shell 26. The plow base 10 is preferably molded as a unitary or singular component of polymer material, that is more slippery than material conventionally used for this purpose. Preferably the material is monopolymer acetal having an additive, for example siloxane, to provide slippery properties to the plow base 10. Preferably, the plow base 10 is composed of 4 to 5% siloxane additive and 96 to 95% acetal. Up to 10% of the siloxane additive may be used, making the plow base 10 more slippery but reducing wear resistance. The plow base 10 includes a circular, upper, mounting segment 36, having an annular rim portion 38 for engagement to the outer shell 26. The plow base 10 is mounted in position by the crimped outer edge of the outer shell 26, which encloses the annular rim portion 38 of the mounting segment 36. An axial central post segment 40 extends upwardly from the mounting segment 36 to a generally convex base swivel surface 42 in congruent surface-to-surface contact with the inner swivel surface of the rivet 19. The post segment is 40 dimensioned 10 of a sufficient height to maintain the shell assembly 22 in tight engagement with the swivel portion 20 of the rivet 19. The swivel portion 20, inner shell 24, outer shell 26 and plow base 10 are dimensioned to allow swiveling motion of the ferrule 12 relative to the plow base 10.

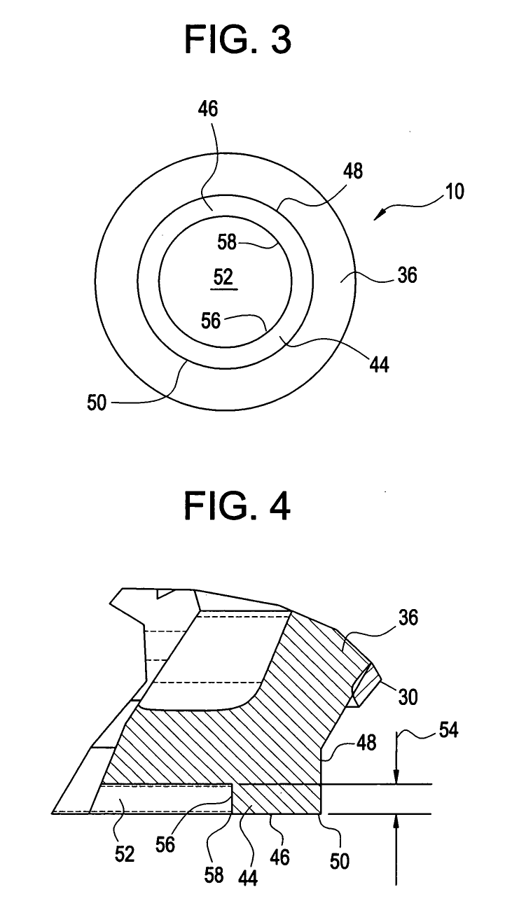

A lower pad segment 44 extends downwardly from the mounting segment 36 of the plow base 10 to a sliding surface 46. The outer wall 48 of the pad segment 44 is substantially perpendicular to the sliding surface 46, forming a sharp outer edge 50. The sharp outer edge 50 of the plow base pad segment 44 acts as a plow when the furniture glide 11 is slid along the floor, for example when a chair having leg mounted furniture glides 11 is slid back from a table. More specifically, dirt or other debris is pushed out of the path of the furniture glide 11 as the furniture to which they are mounted are slid along the floor. The sharp outer edge 50 prevents such dirt or debris from sliding under the plow base 10. The pad segment 44, 44′ may have a circular-shape (FIG. 3), a square shape (FIG. 10), or any other shape, so long as the outer wall 48, 48′ of the pad segment 44, 44′ is substantially perpendicular to the sliding surface 46, 46′.

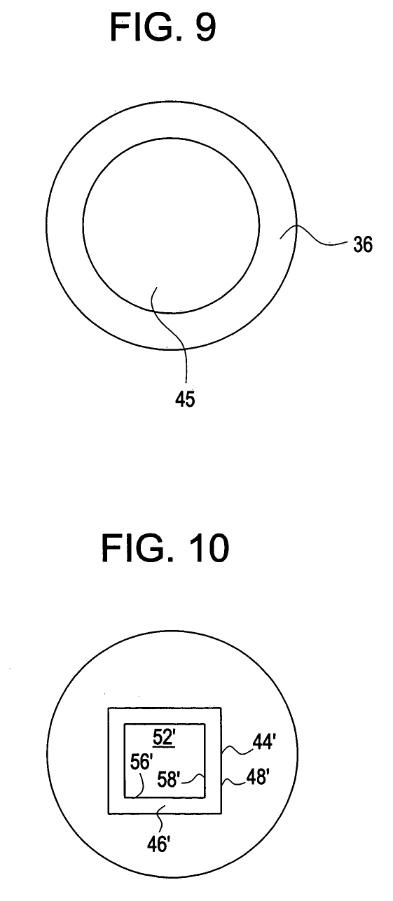

The pad 44, 44′ segment may have an axial recess 52, 52′, preferably having a height 54 of 0.04 inches. The inner wall 56, 56′ of the pad segment 44, 44′ is substantially perpendicular to the sliding surface 46, 46′, forming a sharp inner edge 58, 58′. The sharp inner edge 58, 58′ of the plow base pad segment 44, 44′ acts as a plow after the piece of furniture is initially placed on the floor or after the piece of furniture is moved by lifting it and setting it back down. Any dirudebris that is disposed between the floor and the plow base 10 will be plowed into recess 52, 52′ by the sharp inner edge 58, 58′, if the furniture is then slid along the floor. The recess 52, 52′ may have a circular-shape (FIG. 3), a square shape (FIG. 10), or any other shape, so long as the inner wall 56, 56′of the pad segment 44, 44′ is substantially perpendicular to the sliding surface 46, 46′. Alternatively, the pad segment 45 may be solid and have no recess, as shown in FIG. 9.

Since dirt/debris cannot become trapped between the sliding surface and the floor, the scratching and marring of conventional furniture glides is prevented.

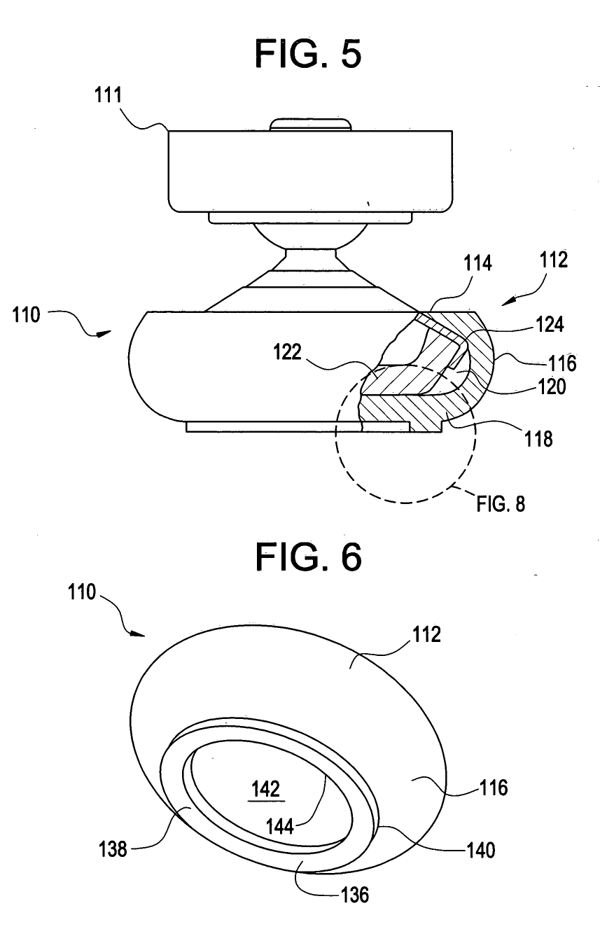

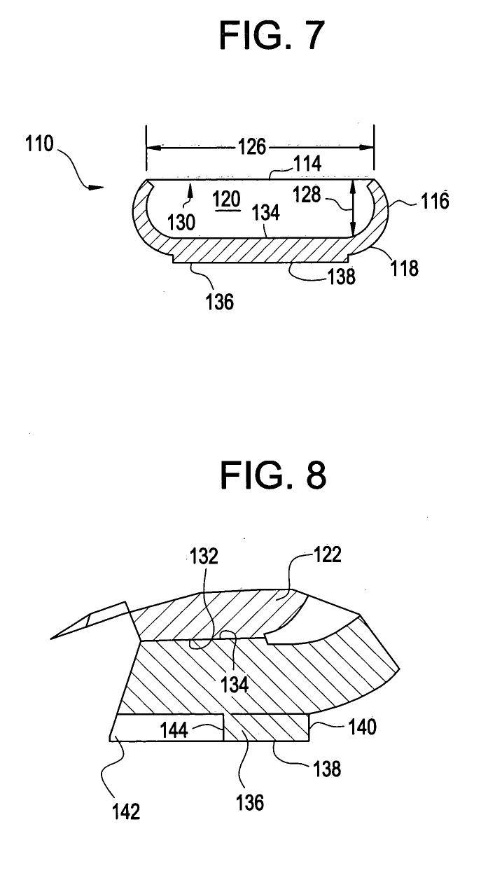

FIGS. 5-8 illustrate a second embodiment of a plow base 110, that is intended for use with installed, conventional furniture glides 111. The plow base 110 is preferably molded as a unitary or singular component of polymer material, that is softer and more slippery than material conventionally used for this purpose. Preferably the material is the acetal/siloxane additive material described above. The plow base 110 includes a circular, upper, mounting segment 112, having a circumferential upper lip segment 114, a circumferential sidewall segment 116 having a C-shaped cross-sectional profile, and a lower base segment 118 forming a cavity 120 for receiving the glide base 122 and the expanded portion 124 of a conventional furniture glide 111. The inner diameter 126 of the sidewall segment 116 and the distance 128 between the lip segment 114 and the base segment 118 may be selected to provide a cavity 120 that can receive any given conventional furniture glide 111. As shown in FIGS. 5 and 8, the material from which the plow base 110 is manufactured is flexible enough that the lip segment 114 may be stretched to widen the opening 130 for receiving the furniture glide 111. After the furniture glide 111 is inserted into the cavity 120, the sliding surface 1321 of the furniture glide 111 rests on the upper surface 134 of base segment 118.

A lower pad segment 136 extends downwardly from the mounting segment 112 of the plow base 110 to a sliding surface 138. As discussed above, the pad segment 136 may have substantially any shape, so long as the outer wall 140 of the pad segment 136 is substantially perpendicular to the sliding surface 138. The pad segment 136 may have an axial recess 142. As discussed above, the axial recess 142 may have substantially any shape, so long as the inner wall 144 of the pad segment 136 is substantially perpendicular to the sliding surface 138.

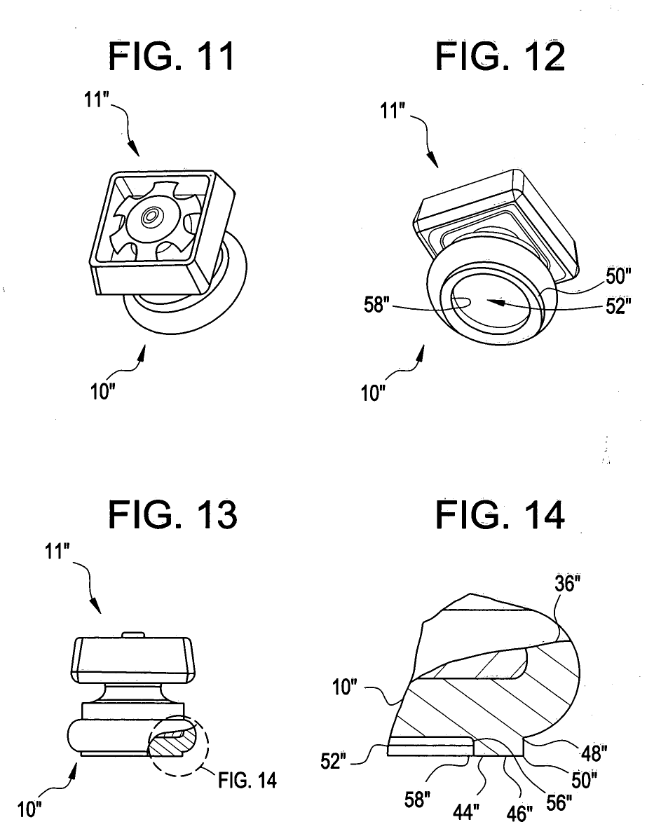

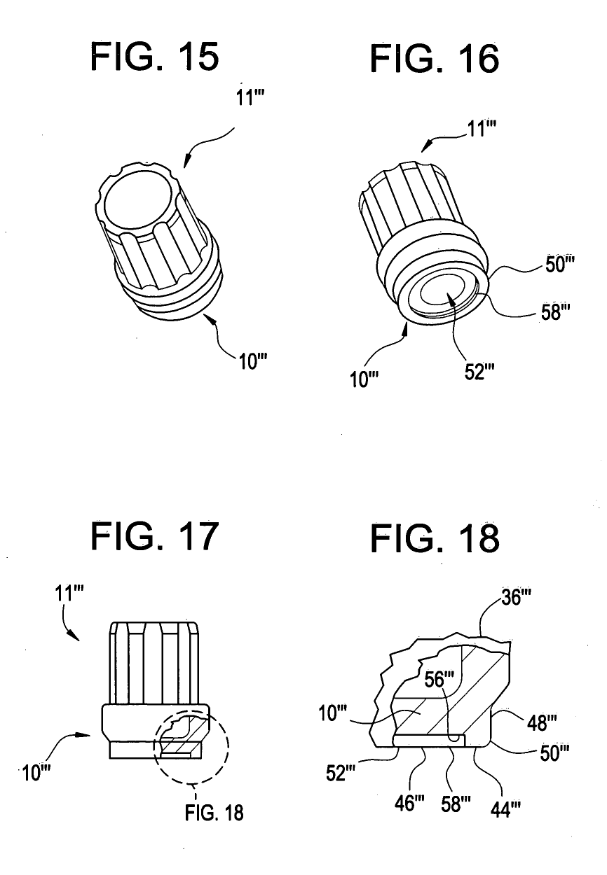

FIGS. 11-14 illustrate a second variety of furniture glide 11″ for use with a tubular furniture leg having a substantially square-shaped cross-sectional profile. In this variety, the plow base 10″ is pivotally attached to the ferrule assembly in a manner similar to that of the first variety of furniture glide 11. FIGS. 15-18 illustrate a third variety of furniture glide 11′″ for use with a furniture leg that may be tubular or solid, and preferably has a substantially circular cross-sectional profile. In this variety of furniture glide 11′″, the plow base 10′″ is integrally formed with the ferrule assembly. The plow base 10″ of furniture glide 11″ and the plow base 10′″ of furniture glide 11′″ are substantially similar to the plow base 10 of furniture glide 11. All of the plow bases 10″, 10′″ include a lower pad segment 44″, 44′″ that extends downwardly from a mounting segment 36″, 36′″ to a sliding surface 46″, 46′″. The outer wall 48″, 48′″ of the pad segment 44″, 44′″ is substantially perpendicular to the sliding surface 46″, 46′″, forming a sharp outer edge 50″, 50′″. The pad 44″, 44′″ segment may include an axial recess 52″, 52′″, having an inner wall 56″, 56′″ that is substantially perpendicular to the sliding surface 46″, 46′″, forming a sharp inner edge 58″, 58′″.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A furniture glide comprising
an upper portion adapted for mounting to a furniture leg and
a lower portion having a plow base including a lower pad segment having an outer wall extending downwardly to a bottom sliding surface adapted for sliding on a floor, the outer wall being substantially perpendicular to the sliding surface, defining a sharp outer edge;
wherein the sharp outer edge of the pad segment acts as a plow when the furniture glide is slid along the floor to push dirt or other debris out of the path of the furniture glide.

2. The furniture glide of claim 1 wherein the sliding surface of the pad segment defines a recess.

3. The furniture glide of claim 2 wherein the recess defines an inner wall that is substantially perpendicular to the sliding surface forming a sharp inner edge, wherein the sharp inner edge acts as a plow when the furniture glide is slid along the floor to push dirt or other debris disposed between the bottom surface and the floor into the recess.

4. The furniture glide of claim 1 wherein the plow base is molded from a polymer material.

5. The furniture glide of claim 4 wherein the polymer material comprises monopolymer acetal.

6. The furniture glide of claim 5 wherein the polymer material also comprises siloxane.

7. The furniture glide of claim 6 wherein the polymer material comprises 4 to 10% siloxane and 96 to 90% monopolymer acetal.

8. The furniture glide of claim 6 wherein the polymer material comprises 4 to 5% siloxane and 96 to 95% monopolymer acetal.

9. The furniture glide of claim 1 wherein the upper portion includes a ferrule assembly adapted for receiving and gripping the furniture leg, the lower portion being pivotally mounted to the upper portion.

10. The furniture glide of claim 1 wherein the upper portion includes a ferrule assembly adapted for receiving and gripping the furniture leg, the lower portion being integrally formed with the upper portion.

11. The furniture glide of claim 1 wherein the furniture glide is a single unitary structure, the upper portion comprises:
a circumferential upper lip segment;
a circumferential sidewall segment having a C-shaped cross-sectional profile; and
a lower base segment;
wherein the lip segment, the sidewall segment and the base segment define a cavity for receiving a conventional furniture glide mounted on the furniture leg.

12. A furniture glide comprising
an upper portion adapted for mounting to a furniture leg and
a lower portion including a lower pad segment molded from a polymer material comprising monopolymer acetal and having an outer wall extending downwardly to a bottom sliding surface adapted for sliding on a floor, the outer wall being substantially perpendicular to the sliding surface, defining a sharp outer edge;
wherein the sharp outer edge of the pad segment acts as a plow when the furniture glide is slid along the floor to push dirt or other debris out of the path of the furniture glide.

13. The furniture glide of claim 12 wherein the sliding surface of the pad segment defines a recess having an inner wall that is substantially perpendicular to the sliding surface, forming a sharp inner edge, wherein the sharp inner edge acts as a plow when the furniture glide is slid along the floor to push dirt or other debris disposed between the bottom surface and the floor into the recess.

14. The furniture glide of claim 13 wherein the polymer material also comprises siloxane.

15. The furniture glide of claim 14 wherein the polymer material comprises 4 to 10% siloxane and 96 to 90% monopolymer acetal.

16. The furniture glide of claim 14 wherein the polymer material comprises 4 to 5% siloxane and 96 to 95% monopolymer acetal.

17. A furniture glide comprising
an upper portion adapted for mounting to a furniture leg and
a lower portion including a lower pad segment molded from a polymer material comprising monopolymer acetal and siloxane, the pad segment having a bottom sliding surface adapted for sliding on a floor, and inner and outer walls extending substantially perpendicularly upward from the sliding surface, the inner wall defining a recess in the sliding surface, the inner and outer walls forming sharp inner and outer edges with the sliding surface, respectively, the inner and outer edges acting as plows when the furniture glide is slid along the floor whereby the outer edge pushes dirt or other debris out of the path of the furniture glide and the inner edge pushes dirt or other debris disposed between the bottom surface and the floor into the recess.

18. The furniture glide of claim 17 wherein the polymer material comprises 4 to 10% siloxane and 96 to 90% monopolymer acetal.

19. The furniture glide of claim 17 wherein the polymer material comprises 4 to 5% siloxane and 96 to 95% monopolymer acetal.
